(19) United States
(12) Patent Application Publication
(10) Pub. No.: US 2004/0155770 A1
(43) Pub. Date: Aug. 12, 2004

(54) Audible alarm relay system

(76) Inventors: Carl V. Nelson, Derwood, MD (US); Jeffery C. Lesho, Brookeville, MD (US)

Correspondence Address: Office of Patent Counsel, The Johns Hopkins University, Applied Physics Laboratory, 11100 Johns Hopkins Road, Laurel, MD, 20723-6099, US

(21) Appl. No.: 10/646,286

(22) Filed: Aug. 22, 2003

Related U.S. Application Data
(60) Provisional application No. 60/405,271, filed on Aug. 22, 2002.

(51) Int. Cl. G08B 1/00

(52) U.S. Cl. 340/531

(57) ABSTRACT

Disclosed herein is an audible alarm relay system comprising a microphone for converting environmental sounds to electrical sound signals; processing circuitry for receiving the electrical sound signals, sampling the sound signals, and analyzing the sampled sound signals to determine if the sampled sound signals contain a sound pattern that matches a stored sound pattern; and an output device for notifying a user that the sampled sound signal contains a sound pattern that matches a stored sound pattern.

### CROSS-REFERENCE TO RELATED APPLICATIONS

This application claims the benefit of prior filed co-pending U.S. Provisional Application No. 60/405,271, filed Aug. 22, 2002, the contents of which are incorporated herein by reference.

### BACKGROUND OF THE INVENTION

1. Field of the Invention

The present invention relates generally to an audible alarm relay system.

2. Description of the Related Art

Hearing loss can be a problem for many segments of the population. As the population gets older and the ability to hear high pitch sounds decreases, it may not always be possible to hear a watch alarm or cell phone ringing. It is common to see people use watch alarms to remind them to take mediation. Often, if the person is active or the watch is under clothing, it is not possible for the person to hear the alarm.

Also, in high noise environments such as factories or airports, the ambient noise levels are so high that it is often impossible to hear a machine alarm or other warning alert. This often places a worker in danger of harm due to the inability to hear the alarm.

Further, high traffic noises can often drown out a police radio system when an officer is on a traffic stop. The officer, while outside of his automobile, might not perceive an important radio call or alert due to the high traffic noise.

As stated earlier, watches with vibration alarms are available, but these existing devices cannot be trained to monitor existing cell phones or personal digital assistants (PDAs) that the use may already own.

Several attempts have been made to solve these problems in the existing systems, each of which still containing several deficiencies.

U.S. Pat. No. 6,218,958 to Eichstaedt et al. discloses an integrated touch-skin notification system for wearable computing devices. A tactile notification device that can be embodied in, e.g., a wristwatch, communicates via wireless link with plural personal computing devices, including cellular telephones, pagers, and palm top computers, of the person wearing the notification device. When one of the personal computing devices alerts, e.g., when the telephone receives an incoming call, the pager receives a page, or the palm top computer receives an email, the personal computing device sends a signal to the notification device, which generates a discrete tactile signal against the person's skin. This device requires extensive wireless communications circuitry that is costly and adds to the size of the device. Also, the small tactile alert might not be perceived in certain environments.

U.S. Pat. No. 5,337,364 to Fitch discloses a communication device for transmitting audio information to a user. A communication device for transmitting audio information includes a compact casing which houses processing circuitry. The processing circuitry converts input audio signals into transducer driving signals. A miniaturized microphone is mounted in the casing for receiving the input audio signals. The input audio signals are then amplified and filtered to appropriate signal levels by the processing circuitry. Once the input audio signals have been processed in this manner they are applied to a driver which outputs transducer driving signals analogous to the input audio signals are received by a transducer assembly worn by a user and energize a pair of coils located on opposite sides of an armature forming part of the transducer assembly. The electromagnetic forces generated by the coils when energized cause the armature to move. Movement of the armature in turn drives a plunger so that the plunger moves in a vibrational pattern analogous to the input audio signals. The plunger contacts the skin of the user so that the vibrational pattern is received by cutaneous nerve receptors on the user's body or by the user's ears via bone conduction. The vibrational information is then transmitted to the user's brain for processing. This system does not provide processing that can differentiate various alarms and alerts, and also works on a tactile alert system that might not be perceived by the user.

U.S. Pat. No. 6,240,392 to Butnaru et al. discloses a communication device and method for deaf and mute persons. A communication device for deaf, hearing impaired, or mute persons comprises a processor control system which makes use of a microphone and a speech recognizer to receive and process audio data (speech or non-speech) to determine whether or not a dangerous situation exits within the environment surrounding the user. Indicator signals which correspond to dangerous or cautionary situations relating to abnormally loud noises, or readily recognized sound patterns, such as a siren may also be displayed to the user, as may be information related geographic location, distance to a preset destination, or other personally useful information. This system can not accurately differentiate between differing alarms and alerts, and does not provide capabilities to learn new alarm or alert sounds.

U.S. Pat. No. 5,839,109 to Iwamida discloses a speech recognition apparatus capable of recognizing signals of sounds other than spoken words and displaying the same for viewing. A speech recognition apparatus includes a sound pickup, a standard feature storage device, a comparing device, a display pattern storing device, and a display. The apparatus can display non-speech sounds either as a message or as an image, and is especially useful for hearing-impaired individuals. For example, if a fire engine siren is detected, the display can show a picture of a fire engine, or can display the message “siren is sounding”. This system can not accurately differentiate between differing alarms and alerts, and does not provide capabilities to learn new alarm or alert sounds.

Japanese Patent 10-000214A2 to Obara Kazuaki discloses an environmental sound detecting device to detect environmental sounds such as a siren being sounded by an ambulance and warning sounds at a pedestrian crossing, to transmit these warnings to a deaf person by the vibration of a vibrating element so that the person is able to avoid various dangerous situations which may be encountered in his daily life. The device consists of a first power measuring device which measures the output power of a filter that analyzes the output of a microphone that inputs sound information and a power comparator which measures the ratio between the output values of the device and a second power measuring device which measures the power of the signals of specific frequency components and detects whether environmental warning sounds such as a siren are included in the sound information or not. When an environmental warning sound is included and detected by the comparator, the detection of an environmental warning is transmitted to the person by the vibration of a vibrating element. This system also can not accurately differentiate between differing alarms and alerts. In addition, this system is limited to determining a sound based only on frequency and power level of the input signal, which can cause erroneous output vibrations.

Japanese Patent 08-083090A2 to Takahashi Kenji et al. discloses an acoustic discrimination device to assist a person who has difficulty in hearing in place of a guide dog for the deaf. Wave analysis is performed by a sound analyzer on several kinds of sound, perception of which is necessary for daily life, such as the sound of door chime, opening/closing of a door, dial tone of a telephone, and fire alarm bell. With these spectra stored preliminarily in a storing means, when a sound is newly generated, its spectrum is compared with the several kinds of stored spectrum by a discriminating means, so that it is discriminated if the sound generated requires any action. The generation of a sound that requires an action would be transmitted to the person having difficulty in hearing through the sensibly vibration by a body sensory vibration means. Thus, a required action is urged correspondingly to the kind of sound by visibly notifying the person of the kind of sound with a display means. The system is limited to a frequency spectra determination. This system requires the use of digital-to-analog converters and a digital processing unit to perform the spectral analysis functions (e.g., digital DFT (Discrete Fourier Transform) or FFT (Fast Fourier Transform) operations) operating continuously to monitor the incoming signal. Performing the digital processing in a continuous fashion is not power efficient for a low power device, e.g., this is computationally expensive as it adds to both the hardware and software resources required to perform the operations. In addition, DFT and FFT functions require relatively long time samples for accurate resolution of the signal.

Other technologies have been considered in an effort to perceive differing alarms and alerts, and accurately relay the perceived alarm or alert to a user, but have not been found beneficial.

### SUMMARY OF THE INVENTION

It is, therefore, an aspect of the present invention to provide an audible alarm relay system for recognizing various alarms or alerts and notifying a user that the alarm or alert is occurring in a power efficient manner for a battery operated device.

It is another aspect of the present invention to provide an audible alarm relay system that can learn different alarms and alerts, recognize the alarms or alerts, and notify a user that the alarm or alert is occurring.

It is yet another aspect of the present invention to enhance the recognition capabilities of the present invention by adding noise cancellation processing to the system.

In accordance with another aspect of the present invention, there is provided a method of providing an audible alarm relay system that can recognize various alarms or alerts and notify the user that the alarm or alert is occurring in a power efficient manner for a battery operated device.

In accordance with yet another aspect of the present invention, there is provided a method of teaching differing alarms and alerts to an audible alarm relay system that can recognize the alarms or alerts and notify the user that the alarm or alert is occurring.

The foregoing aspects of the present invention are realized by an audible alarm relay system, comprising a microphone for converting environmental sounds to electrical sound signals; processing circuitry for receiving the electrical sound signals, one of low-power analog time-domain and time-sampling of the sound signals, one of analog and time domain correlation with a stored sound pattern, and analyzing the sampled sound signals via band-pass filtering and correlation to determine if the sampled sound signals contain a sound pattern that matches a stored sound pattern; and an output device for notifying a user that the sampled sound signal contains a sound pattern that matches a stored sound pattern.

The system can be further enhanced wherein the audible alarm relay system further comprises noise cancellation circuitry.

The foregoing aspects of the present invention are also realized by a method for relaying an audible alarm, comprising the steps of storing a sound pattern of at least one audible alarm in an analog memory such as a charge coupled device (CCD) but not limited to a CCD; monitoring the environment through a microphone; determining if a sound is detected in the environment; analyzing the detected sound if a sound is detected; determining if a sound pattern of the detected sound matches a sound pattern stored in the memory; and outputting a secondary alarm if a matching sound pattern is found.

### BRIEF DESCRIPTION OF THE DRAWINGS

The above and other objects, features and advantages of the present invention will become more apparent from the following detailed description when taken in conjunction with the accompanying drawings.

FIG. 1 is a block diagram of the basic audible alarm relay system according to an embodiment of the present invention;

FIG. 2 is a block diagram of the processor of FIG. 1;

FIG. 3 is a flow chart depicting the operation of the audible alarm relay system according to an embodiment of the present invention;

FIG. 4 is a flow chart depicting the operation of the training operation of FIG. 3;

FIG. 5 is a block diagram illustrating the noise cancellation feature according to the present invention; and,

FIG. 6 is a block diagram of the audible alarm relay system utilizing according to another embodiment of the present invention.

### DETAILED DESCRIPTION OF THE PREFERRED EMBODIMENTS

A preferred embodiment of the present invention will be described herein below with reference to the accompanying drawings. In the following description, well-known functions or constructions are not described in detail since they would obscure the invention in unnecessary detail.

A main premise of the present invention is to provide a system that can amplify a particular alarm signal without amplifying ambient noise. This end is primarily accomplished by training the system to only detect the particular alarm using a low-power device. The device will learn the envelope of alarm repetition rate. In the prior art, in order to see the relatively long time envelope of the alarm signal in the frequency domain would require many digital samples that would be difficult in a small low-power device.

The disclosed invention details an electronic device that would be worn close to the ear (i.e. on eyeglasses or in the ear as a hearing aid) that would listen for a watch alarm or a cell phone ring or a PDA alarm and then provide another audible cue to the user. The user would then hear the alarm and be reminded to take the medicine, attend an appointment or do what ever the alarm was set for. The relay system according to the present invention would mount on glasses or earrings to provide speaker next to ear for easier perception of the alarm. Of particular interest is to build an add-on device to existing appliances that does not require a change to the existing appliances and at the same time is compatible with any audible alarm.

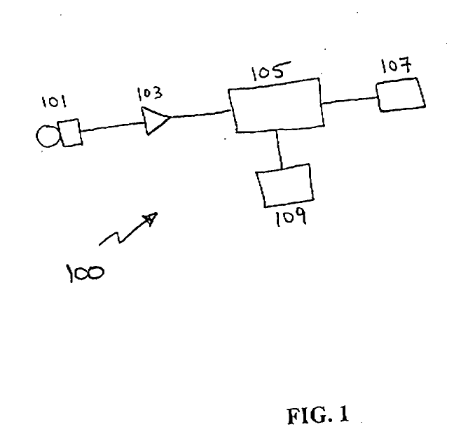

FIG. 1 is a block diagram of the basic audible alarm relay system according to an embodiment of the present invention. The device would be unobtrusively mounted on a set of eyeglasses, in a pair of earrings or on an ear clip similar to a hearing aid or radio. In addition to an audible alert, the device can be constructed to output a visual signal such as an LED, or a tactile signal such as a vibration. If the LED is used, the LED can be mounted at the hinge of the glasses, so that only the user can see it. The speaker can be mounted to direct the sound energy into the users ear.

Shown in FIG. 1 are microphone 101 for receiving sounds, amplifier 103 for amplifying the received sounds, processor 105 for performing various processing functions, which will be described in further detail below, output device 107 for outputting a relayed audible alarm, and memory 109 for storing alarm characteristics and operating programs. Although the output device in the preferred embodiment is a speaker, other output devices are contemplated. Among them are an LED as stated earlier, a tactile sensor, a visual display, or other apparatus that can alert the user that the alarm is sounding.

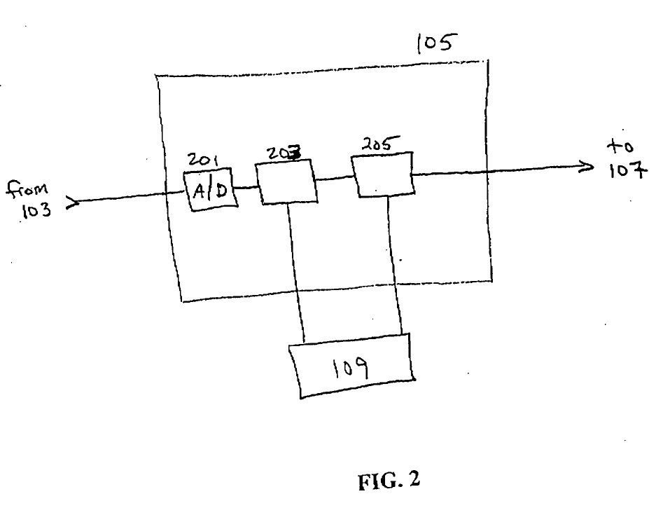

FIG. 2 is a block diagram of the processor of FIG. 1 executed in the digital domain. A set of similar functions can be preformed using analog circuits such as operational amplifiers (band pass filtering, correlation and thresholding).

In the analog embodiment of the present invention, time series analysis is performed by either analog or digital techniques. Generally, a signal is stored in a memory such as a CCD device and correlated in the time domain with a signal input through a microphone. To determine if the input signal matches the signal stored in memory, a subtraction of the signals can be performed, but other methods are available. If the subtraction produces a zero result, i.e. correlation function=1, it is determined that the two signals are identical. If the subtraction results in a non-zero result, i.e. a correlation function≠1, it is determined that the signal are not identical. Of course, parameters can be set to allow for slight variations in the correlation function that will still produce a “match”. By correlating the two signals in the time domain, valuable and extensive power, hardware and software resources can be saved.

Shown in FIG. 2 are analog-to-digital (A/D) converter 201 for converting a received analog sound to a digital signal for processing, band pass filter 203 for filtering out of the digital signal all frequencies that are not associated with a stored alert, and rate detector 205 for detecting rates at which the passed frequencies occur. As stated earlier, the A/D converter 201 can be removed and the processing can occur in the analog time domain. In the analog time domain, A/D converter 201 is replaced with an analog sampler. Band pass filter 203 and rate detector 205 are shown connected to memory 109 for conducting two main processes. First, a training subroutine is stored in memory 109 to enable the audible alarm relay system to learn different sounds that will trigger the system to relay an alarm. The training operation allows the system to analyze distinct alarms and store the frequency and rate of the alarm in memory 109 for use in a normal operation detection mode. The frequency is the tone or pitch of the alarm and can vary in each alarm. The rate is the audible pattern at which the frequencies occur. For example, a single tone alarm is sounded at one frequency and at a steady rate, whereas a cellular telephone can be programmed to output a ring tone such as a song that has varying frequencies and varying rates. The system according to the present invention can be trained to learn both of the foregoing examples, as well as other sound patterns.

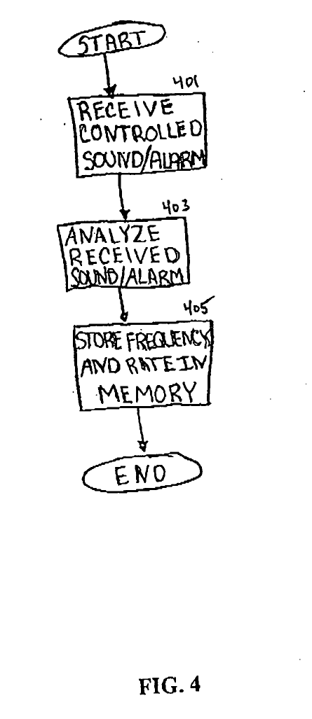

By storing both the frequency and rate of the trained alarms, the system can specifically distinguish between differing alarms and alerts. For example, a machine located in a factory has an alarm to signal a problem. The alarm sounds at a particular frequency and at a particular rate. If the factory has several machines with alarms to signal various problems, each operator can have a system according to the present invention trained to detect his own alarm. Each system stores the frequency and rate of the alarm of the particular machine that the machinist is using, and if the alarm sounds, the system will detect the frequency and rate of the alarm and relay the alarm to the user, via one of the output methods. The operation of the training subroutine will be described in further detail with respect to FIG. 4.

Returning again to FIG. 2, the rate detector 205 can be embodied by a wideband sonic detector that samples at a rate sufficient to detect the highest frequency expected from the primary alarm. The processor 105 would provide all the filtering using standard signal processing techniques. By performing all filtering with software, the largest variety of alarms can be monitored.

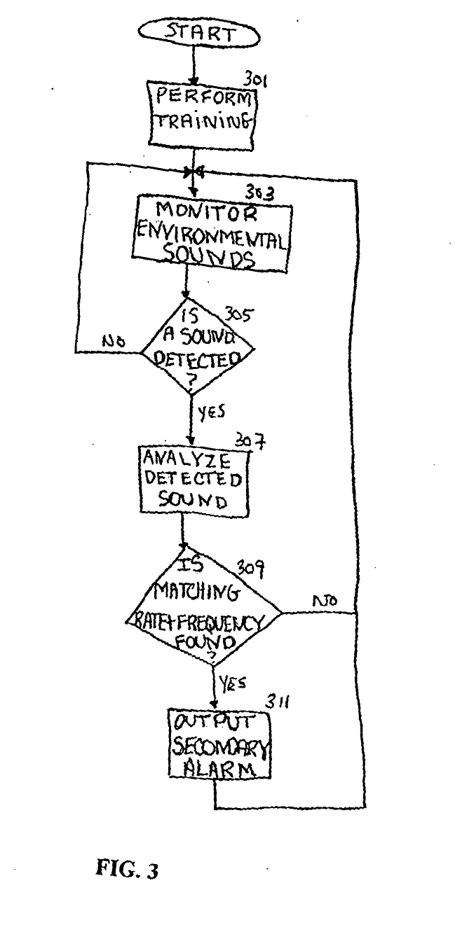

FIG. 3 is a flow chart depicting the operation of the audible alarm relay system according to an embodiment of the present invention. The operation of the audible alarm relay device will now be described with respect to FIGS. 1, 2 and 3. In step 301, the user initially trains the system by activating the alarm to be monitored and holding the system up to this alarm. Microphone 101 receives the alarm and amplifies the sound in amplifier 103. The amplified sound is then passed to processor 105 for processing. The system learns the characteristics of the alarm by determining the frequency and repetition rate of the alarm. Band pass filter 203 and rate detector 205 in conjunction with the training subroutine stored in memory 109 carry out this process. The frequency and rate are then stored in memory 109. Also stored in memory 109 and associated with each stored alarm characteristics is the selected output alarm. After the training session is over, the system, in step 303, would then listen to the environment and continuously monitor it through microphone 101 and listen for the same frequency and rate of an alarm for which it was trained. Sounds are detected in step 305. If no sounds are detected, i.e. a silent environment, the process returns to step 303 to continue monitoring. If sounds are detected, the process goes to step 307 to analyze the detected sound. Any detected sounds are fed through microphone 101 to amplifier 103 for amplification. The amplified sounds are fed into processor 105 where they are converted to a digital signal in A/D converter 201. The digital signal is analyzed by a detection subroutine store in memory 109. Band pass filter 203 and rate detector 205 constantly monitor for a frequency and rate matching a frequency and rate stored in the system, in step 309. If no matching frequency and rate are detected the process returns to step 303 to continue monitoring. Upon detecting a characteristic sound pattern at the correct frequency and rate in step 309, the process continues to step 311 and the system then produces another alarm, or “relays” the alarm, that the user can perceive, which is output at output device 107. The second alarm can be simply a louder audible alarm produced closer to the ear, or it can be an LED mounted in the frame of eye glasses that blinks when the alarm goes off. The alarm can also be a see through heads up display of time placed on the lens of eyeglasses that the user can see all the time. The secondary alarm can be shifted to a lower frequency, or simply another frequency that the user can hear.

FIG. 4 is a flow chart depicting the operation of the training operation of FIG. 3. In step 401 the system receives a controlled sound or alarm. By “controlled”, it is meant that the actual sound or alarm that is to be monitored should be the only sound input into the system during training; a silent environment provides the best training. In step 403 the system analyzes the sound and extracts the frequency and rate of the input sound. In step 403 the frequency and rate are stored in memory 109. The system can be trained for an alarm as in the above example, or other sounds, including but not limited to a telephone ring tone, a doorbell, a baby crying, a car horn, etc. Various parameters and sensitivities can also be set to allow for differing performance.

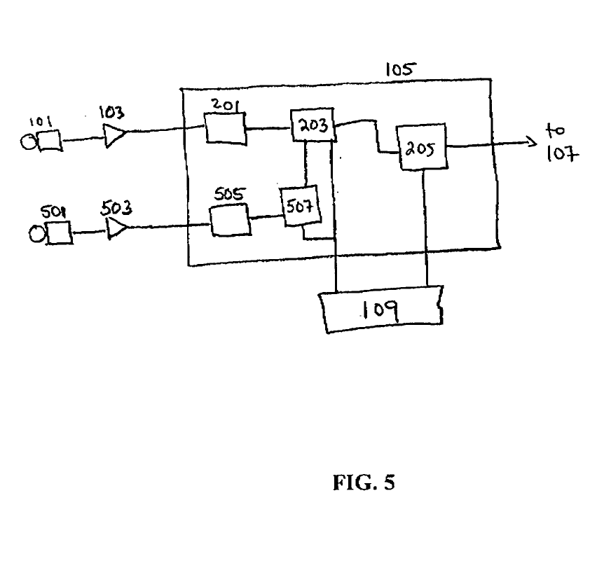

FIG. 5 is a block diagram illustrating the noise cancellation feature according to the present invention. Shown in FIG. 5 are the additional elements of a noise canceling microphone 501 for receiving ambient noise, amplifier 503 for amplifying the received ambient noise, A/D converter 505 for converting the amplified ambient noise to a digital signal, and noise cancellation circuitry 507 for canceling out ambient noise from the received sounds.

The operation of the noise cancellation feature of the present invention will now be described with respect to FIG. 5. As the operation of microphone 101, amplifier 103 and A/D converter 201 remain the same; a description of their operation will be omitted. Also, as noise cancellation is well known in the art, only a cursory explanation will be provided. Noise cancellation microphone 501 receives ambient noise and feeds the ambient noise to amplifier 503 for amplification. The amplified ambient noise is fed to A/D converter 505 for conversion to a digital signal. The digital signal is forwarded to the noise cancellation circuitry 507. The ambient noise is then filtered from the main signal to further facilitate alarm detection.

The present invention can be expanded to existing technology via the learning mode, and the existing market void would be quickly filled. With pre-existing systems, users are required to buy all new appliances with vibration alarms to replace what they could not longer hear. Phones in pockets or briefcases will not alert the user on vibration mode because the vibration would not be easy to feel on a low powered device. The disclosed device could detect a ringing phone in a purse or brief case and alert the user with a secondary alarm.

In an additional embodiment of the present invention, an RF link (i.e. Bluetooth) could be installed in the watch, phone, or PDA that sends a silent signal to the alarm remote. This would be a system that can be used in libraries or meetings or churches where an audible alarm would be disruptive.

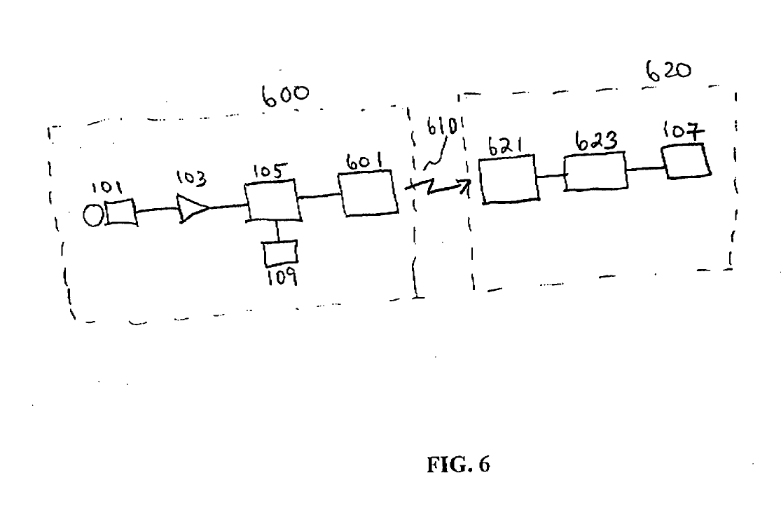

FIG. 6 is a block diagram of the audible alarm relay system utilizing the wireless embodiment. The system according to the present invention would be separated into two devices. A first device 600 would process the sound signals and include a transmitter 601 to wirelessly transmit an alarm command signal 610 to a second device 620. The second device 620 would include a wireless receiver 621, a processor 623 and the output device 107, and would receive the alarm command signal 610 and output the secondary alarm.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An audible alarm relay system comprising:
a microphone for converting environmental sounds to electrical sound signals;
processing circuitry for receiving the electrical sound signals, and analyzing the sound signals to determine if the sound signals contain a sound pattern that matches a stored sound pattern; and
an output device for notifying a user that the digital sound signal contains a sound pattern that matches a stored sound pattern.

2. The audible alarm relay system of claim 1, wherein the processing circuitry comprises:
a processor for controlling the system;
a time sampler for sampling the sound signals;
a memory for storing the stored sound patterns;
a band pass filter for determining if the sampled sound signals contain at least one frequency that matches a stored frequency; and
a rate detector for determining if the sampled sound signals contain at least one rate that matches a stored rate.

3. The audible alarm relay system of claim 2, wherein the output device notifies the user if the processing circuitry determines that the sampled sound signal contains both a frequency and a rate that matches a stored sound pattern.

4. The audible alarm relay system of claim 3, wherein the output device is one of an audio, visual and tactile device.

5. The audible alarm relay system of claim 1, wherein the audible alarm is any predetermined sound.

6. The audible alarm relay system of claim 1, further comprising noise cancellation means for monitoring the ambient noise and canceling the ambient noise from the environmental sounds.

7. The audible alarm relay system of claim 1, wherein the processing circuitry comprises:
a processor for controlling the system;
a time sampler for sampling the sound signals;
a correlator for correlating the sound signal with the stored sound pattern; and
an analog memory for storing the stored sound patterns.

8. The audible alarm relay system of claim 7, wherein the time sampler performs the time sampling in one of the analog domain and digital domain.

9. The audible alarm relay system of claim 7, wherein the correlator performs the correlation in one of the analog domain and digital domain.

10. The audible alarm system of claim 1, wherein the system is an after-market add-on device for detecting pre-existing sound signals.

11. The audible alarm system of claim 1, further comprising:
a transmitting unit, having the microphone and processing circuitry, for transmitting a wireless alarm command signal if a matching sound pattern is found; and
a receiving unit having second processing circuitry and the output device for receiving the alarm command signal and notifying the user that the alarm command signal has been received.

12. A method for relaying an audible alarm, comprising the steps of:
storing a sound pattern of at least one audible alarm in a memory;
monitoring the environment through a microphone;
determining if a sound is detected in the environment;
analyzing the detected sound if a sound is detected;
determining if a sound pattern of the detected sound matches a sound pattern stored in the memory; and
outputting a secondary alarm if it is determined that a matching sound pattern is stored in the memory.

13. The method for relaying an audible alarm of claim 12, wherein the storing step comprises the steps of:
inputting the sound pattern of the at least one audible alarm through the microphone;
analyzing the input sound pattern; and
storing the sound pattern in memory.

14. The method for relaying an audible alarm of claim 13, wherein the analyzing step determines the frequency and rate of the sound pattern and stores the frequency and rate of the sound pattern in the memory.

15. The method for relaying an audible alarm of claim 12, further comprising the steps of monitoring the ambient noise and canceling the ambient noise from the environmental sounds.

16. The method for relaying an audible alarm of claim 12, wherein the analyzing step comprises the steps of:
time sampling the sound signals;
correlating the sound signal with the stored sound pattern.

17. The method for relaying an audible alarm of claim 12, wherein the time sampling is performed in one of the analog domain and digital domain.

18. The method for relaying an audible alarm of claim 12, wherein the correlating is performed in one of the analog domain and digital domain.

19. The method for relaying an audible alarm of claim 12, wherein the method is performed in an after-market add-on device for detecting pre-existing sound signals.

20. The method for relaying an audible alarm of claim 12, further comprising the steps of:
transmitting from a wireless transmitter a wireless alarm command signal if a matching sound pattern is found; and,
receiving at a wireless receiver the alarm command signal and notifying the user that the alarm command signal has been received.

21. An audible alarm relay system comprising:
a memory for storing the frequency and rate of at least one predetermined sound pattern;
a microphone for converting environmental sounds to electrical sound signals;
an analog to digital converter for converting the electrical sound signals to digital sound signals;
a processor for determining if the digital sound signals contain at least one frequency that matches a stored frequency, and determining if the digital sound signals contain at least one rate that matches a stored rate; and
an output device for notifying a user if the processing circuitry determines that the digital sound signal contains both a frequency and a rate that matches the frequency and rate of the at least one predetermined sound pattern.

22. The audible alarm relay system of claim 21, wherein the output device is one of an audio, visual and tactile device.

23. The audible alarm relay system of claim 21, wherein the audible alarm is any predetermined sound.

24. The audible alarm relay system of claim 21, further comprising noise cancellation means for monitoring the ambient noise and canceling the ambient noise from the environmental sounds.

25. A method for relaying an audible alarm, comprising the steps of:
inputting a sound pattern of at least one audible alarm through a microphone;
analyzing the sound pattern of the at least one input audible alarm;
storing the sound pattern in memory;
monitoring the environment through the microphone;
determining if a sound is detected in the environment;
analyzing the detected sound if a sound is detected;
determining if a sound pattern of the detected sound matches a sound pattern stored in the memory; and
outputting a secondary alarm if it is determined that a matching sound pattern is stored in the memory.

26. The method for relaying an audible alarm of claim 25, wherein the analyzing step determines the frequency and rate of the sound pattern and stores the frequency and rate of the sound pattern in the memory.

27. The method for relaying an audible alarm of claim 25, further comprising the steps of monitoring the ambient noise and canceling the ambient noise from the environmental sounds.
